(19) United States
(12) Patent Application Publication
(10) Pub. No.: US 2007/0068323 A1
(43) Pub. Date: Mar. 29, 2007

(54) Selector lever and method for producing a selector lever

(76) Inventor: Junge Dieter, Grunendeich (DE)

Correspondence Address: WILLIAM COLLARD;COLLARD & ROE, P.C., 1077 NORTHERN BOULEVARD, ROSLYN, NY, 11576, US

(21) Appl. No.: 10/575,521

(22) PCT Filed: Oct. 5, 2004
(86) PCT No.: PCT/EP04/11096

§ 371 Date: May 26, 2006

(30) Foreign Application Priority Data
Oct. 11, 2003 (DE) 103 47 347.5

(51) Int. Cl. G05G 1/04

(52) U.S. Cl. 74/523

(57) ABSTRACT

The invention relates to a selector lever, in particular for a motor vehicle transmission, which is guided within a gate shift slot. For damping when the selector lever knocks against the inner edge of the gateshift slot, a sleeve is provided, which is designed to be soft on the outside and on the inside is arranged rotatably with respect to the selector lever shank.

The invention relates, according to patent claim 1, to a selector lever and, according to patent claim 7, to a method for producing a selector lever.

DE 199 08 101 C1 already discloses a selector lever according to the preamble of patent claim 1. The selector lever is guided within a gate shift slot. In order to damp knocking noises of the selector lever shank against the inner edge of the gate shift slot, an elastomeric damper is provided on the inner edge of the gate shift slot.

The object of the invention is to provide an especially convenient selector lever.

According to one advantage of the invention, no sliding friction occurs between the selector lever and the inner edge of the gate shift slot, so that the selector lever rolls in an agreeable way on said inner edge.

When the rolling body is manufactured from a vibration-damping material, a knocking of the selector lever against the inner edge of the gate shift slot does not lead to a knocking noise having a cheap ring to it, but, instead, to a gentle knock having an expensive feel.

If the outer surface area of the rolling body, which may be designed particularly as a sleeve, is made slightly elastic or even elastomeric, a high rolling friction on the rolling surface can be achieved in addition to the vibration-damping effect. This rolling friction rules out a sliding friction which has the corresponding adverse effects.

As compared with a shift lever housing according to DE 199 08 101 C1, the mounting of the selector lever according to the invention is less complicated and is therefore cost-effective. The shift lever housing or selector lever housing may be manufactured cost-effectively from one part in an especially advantageous way, since the vibration-insulating function is implemented in the selector lever or shift lever. According to the invention, the shift lever housing may be produced so as to be especially thin-walled and therefore easily and cost-effectively.

It is especially advantageous to use the selector lever according to the invention in gate shift slots, the shape of which functionally integrates a knocking of the selector lever against the inner edge of the gate shift slot. Such functional integration is afforded, for example, in stepped “P-R-N-D” gate shift slots. In these, an inadvertent movement of the selector lever, for example, “D” to “R” is prevented if only in that, in the case of a rectilinear introduction of force from “D”, the selector lever knocks against a step.

The method according to patent claim 7 allows an especially simple mounting of a selector lever according to the invention.

If the selector lever shank is not yet assembled together with the manual shift knob, a sleeve of the selector lever can be drawn over the selector lever shank into the end position in an especially advantageous way. The manual shift knob can subsequently be fastened to the selector lever shank.

Further advantages of the invention may be gathered from the further patent claims, the description and the drawing.

The invention is explained below by means of several exemplary embodiments.

In the drawing:

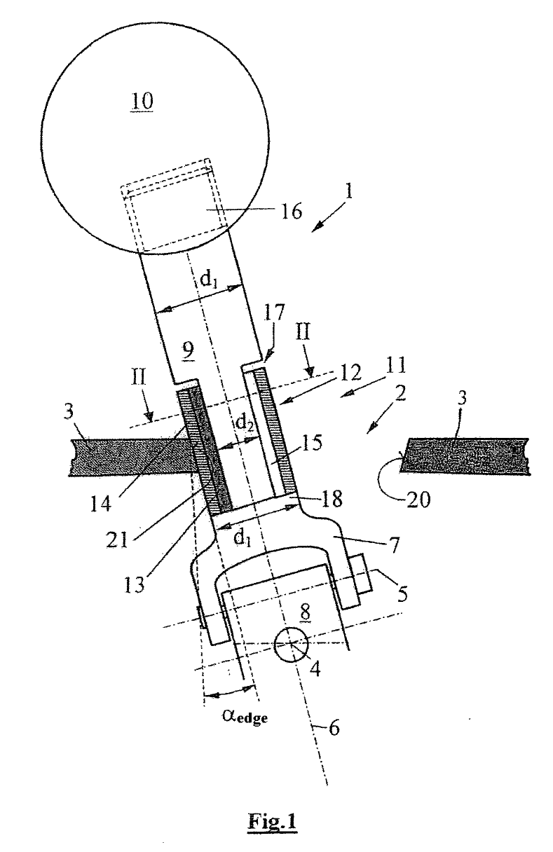

FIG. 1 shows a selector lever which is guided within a gate shift slot,

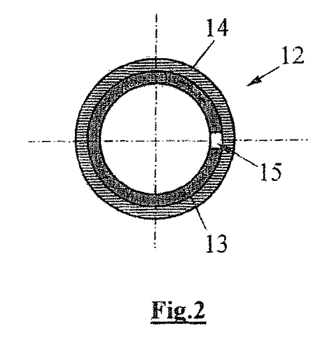

FIG. 2 shows a section through the abovementioned selector lever, which runs along the line II-II of FIG. 1 and mainly shows a two-component sleeve,

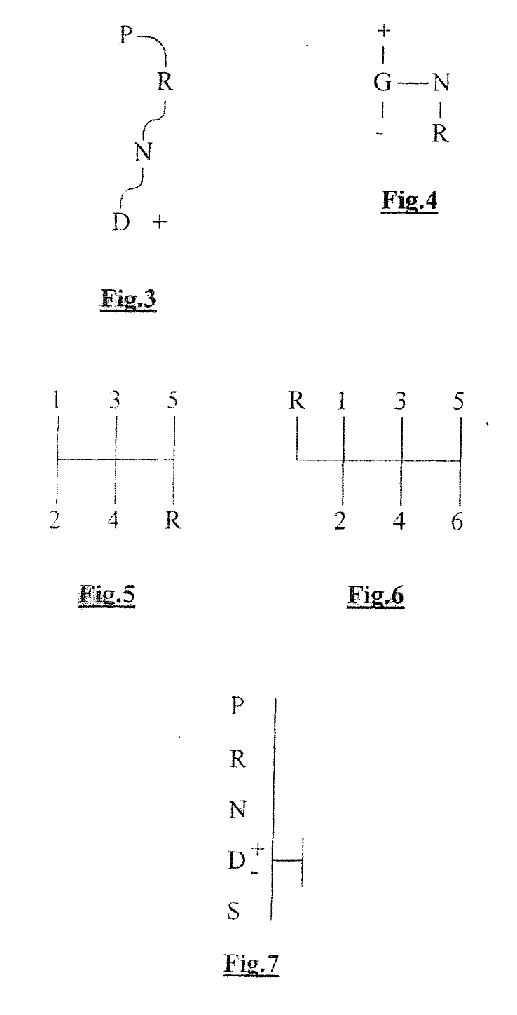

FIG. 3 shows a first possible configuration of selection positions of the selector lever within a stepped “P-R-N-D” gate shift slot of an automatic transmission,

FIG. 4 shows a second possible configuration of selection positions of the selector lever within a gate shift slot of an automated manual shift transmission,

FIG. 5 shows a third possible configuration of shift positions of the selector lever within a gate shift slot of a manual shift transmission,

FIG. 6 shows a fourth possible configuration of shift positions of the selector lever within the gate shift slot of a further manual shift transmission,

FIG. 7 shows a fifth possible configuration of shift positions of the selector lever within the gate shift slot of a further automatic transmission,

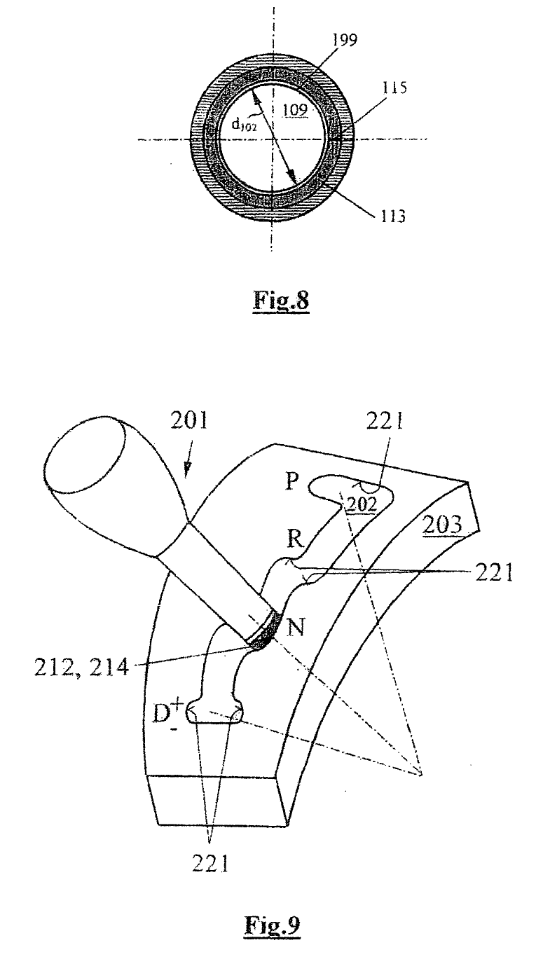

FIG. 8 shows an alternative embodiment of the two-component sleeve according to FIG. 2,

FIG. 9 shows a selector lever which is pivotable along a curved “P-R-N-D” gate shift slot,

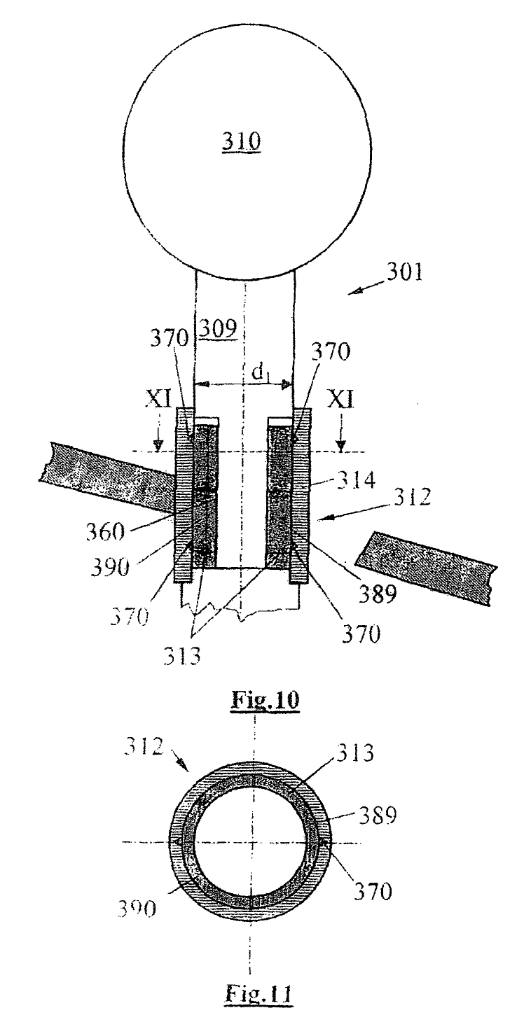

FIG. 10 shows a further alternative embodiment of the selector lever, and

FIG. 11 shows a section through the abovementioned selector lever, which runs along the line XI-XI of FIG. 10 and shows mainly a two-component sleeve.

FIG. 1 shows a selector lever 1 of a motor vehicle transmission, not illustrated in any more detail, said selector lever being guided within a gate shift slot 2.

The selector lever 1 is in this case pivotable within a selector lever housing 3 about two pivot axes 4, 5 arranged orthogonally to one another in various planes.

One pivot axis 4 is in this case also perpendicular to the longitudinal axis 6 of the selector lever 1, that is to say this pivot axis 4 is perpendicular to the drawing plane. To produce these two pivot axes 4, 5 perpendicular to one another, a cardan joint is arranged in the region of the two pivot axes 4, 5. By means of signal generators, not illustrated in any more detail, on two joint halves 7, 8 of the cardan joint and signal receivers on the selector lever housing 3, the selection positions or shift positions of the selector lever can be determined. The possible selection or shift positions are in this case illustrated in various alternatives in FIG. 3 to FIG. 7. In the case of the manual shift transmissions according to FIG. 5 and FIG. 6, however, there are no signal generators and receivers used, but, instead, the selector lever 1 functions as a shift lever and is coupled directly to an internal shift of the respective transmission. The following meanings apply in FIG. 3 to FIG. 7:
“P”—parking position
“R”—reverse gear/reverse driving range,
“N”—neutral position/idling,
“D”—automatic gear selection/driving range selection/step-up selection,
“G”—basic position
“+”—sequential upshift/upshift limitation up,
“−”—sequential downshift/upshift limitation down,
“1”—first forward gear,
“2”—second forward gear,
“3”—third forward gear,
“4”—fourth forward gear,
“5”—fifth forward gear,
“6”—sixth forward gear.

The upper joint half, illustrated in FIG. 1, of the cardan joint 7 is connected to a shank 9 of the selector lever 1. This shank 9 consists of steel. At the upper end of the shank 9, there is a manual shift knob 10 which is screwed onto a thread 16 and by means of which the operator can pivot the selector lever 1 manually into its selection or shift positions about the two pivot axes 4, 5.

The shank 9 has, above and below a knock-on region 11, a diameter d1 which is larger than the diameter d2 in the knock-on region 11. An annular groove, which is concentric to the longitudinal axis 6 of the selector lever 1, is thus formed in the knock-on region 11. This annular groove has inserted into it a two-component sleeve 12 which is thus concentric and rotatable with respect to the shank 9. This two-component sleeve 12 consists of two sleeves 13, 14 which are arranged coaxially to one another and of which the radially inner sleeve 13 is slotted in the longitudinal direction. A slot 15 which is thus formed is also evident in FIG. 2 and is very narrow.

The slotted inner sleeve 13 consists of perfluoroalkoxylalkane which, abbreviated, is also designated as POM. POM is a very hard material with a nevertheless relatively large elastic range and has a relatively low coefficient of friction. By contrast, the outer sleeve 14 consists of a thermoplastic elastomer which is very soft and stretchable, has high damping and has a relatively high coefficient of friction.

To mount the two-component sleeve 12 onto the selector lever 1, the manual shift knob 10 is demounted, that is to say unscrewed from the thread 16. The complete two-component sleeve 12 is expanded radially until it can be drawn over the thread 16. The two-component sleeve 12 is subsequently drawn downward over the shank 9 until it jumps into the annular groove in the knock-on region 11. Since the annular groove has a greater axial length than the two-component sleeve 12, an axial play 17 is obtained. This axial play lies above the two-component sleeve 12, since the latter bears against the lower groove step 18 as a result of gravity.

Each of the gate shift slots, illustrated merely diagrammatically and by way of example in FIG. 3 to FIG. 7, has a slot width which overshoots the outside diameter of the two-component sleeve 12 in the installed state. This ensures that, during movements of the selector lever 1, the two-component sleeve 12 bears
either against no inner edge 20 or 21 of the gate shift slot at all or
solely against one inner edge 20 or 21 of the gate shift slot.

If, then, the selector lever 1 is guided by the operator with a rolling contact of the two-component sleeve 12 along one inner edge 21, the two-component sleeve 12 rotates about the longitudinal axis 6. In order to achieve theoretical linear contact between
the inner edge 21 on the selector lever housing 3 and
the two-component sleeve 12, the entire inner edge 20, 21 extending peripherally around the gate shift slot is beveled. The bevel angle αedge which is thus formed is in this case not the same at any point on the inner edge 20, 21, but varies over the peripherally extending inner edge 20, 21. The bevel angle αedge varies in such a way that at any point it is parallel to the longitudinal axis 6 of the selector lever 1 when the latter is in contact with the respective point on the inner edge 20 or 21. Since the outer sleeve 14 consists of a soft material, there is, at the point, only theoretically a linear contact and in technical actuality a surface contact. Owing to the softness of the material, several aims are achieved.

The large-area contact of the selector lever 1 with the selector lever housing 3 which is caused by the soft material ensures low stresses in the contact region of the selector lever housing 3. The selector lever housing 3 can thus be manufactured from a thin, lightweight and cost-effective material, without the risk that the selector lever 1 destroys the selector lever housing 3 under misuse forces. Such misuse forces arise, inter alia, when a vehicle occupant tries to climb over the selector lever 1 during a change of seats and is caught on the selector lever 1.

The soft material has a high coefficient of friction which ensures a continuous rolling movement of the two-component sleeve 12.

The soft material damps the vibrational transmission of drive train vibrations from the selector lever 1 to the selector lever housing 3.

The soft material damps the knocking noises in the case of an excessive introduction of force during shifting/selection by means of the selector lever.

In an alternative embodiment according to FIG. 8, the slot 115 in the radially inner sleeve 113 may be selected to be so narrow that the two edges of the slot 115 butt one against the other in the installed state of the two-component sleeve 112. This can also ensure a play 199 between the shank 109 in the region of the diameter dl02 and the radially inner sleeve 113, so that the latter can rotate about the shank 109 and safety against jamming is afforded.

FIG. 9 shows a possible use of the selector lever 201 according to FIG. 1 and FIG. 2 in a gate shift slot shape according to FIG. 3. This is a stepped “P-R-N-D” gate shift slot 202. As a result of this stepping, a knocking of the selector lever 201 against the inner edge 221 of the selector lever housing 203 during forward and rearward pivoting movements is positively induced. The knocking noises are damped in a convenient way by means of the soft radially outer sleeve 214. The gate shift slot 202 three-dimensionally follows the pivoting movement path of the selector lever 201. That is to say, during the pivoting of the selector lever 201, the two-component sleeve 212 follows the curved path of the gate shift slot 202 incorporated into the selector lever housing 203. This ensures, over the entire movement of the selector lever 201, that there is always rolling contact and scarcely any sliding friction between the two-component sleeve 212 and the inner edge 221. A sliding friction fraction may be ruled out completely if the two-component sleeve is designed with a conical outer surface area which intrinsically already follows a circular path. Such a sleeve with a conical outer surface area does not necessarily in this case have to consist of two components, but may even be a one-part sleeve.

FIG. 10 and FIG. 11 show a selector lever 301 in an alternative embodiment. In this case, FIG. 11 illustrates a two-component sleeve 312 of the selector lever 301 in a section along the line XI-XI of FIG. 10. The two-component sleeve 312 comprises, as an inner sleeve 313, two relatively hard half shells 390 and 389 which are configured identically. These two half shells 390 and 389 are surrounded by the outer sleeve 314, the inside diameter of which is larger, with slight play, than the shank diameter d1 in the upper region of the shank 309. This sleeve 314 has damping properties.

Since, in principle, the sleeve 314 is displaceable back and forth coaxially on the shank 309, to mount the selector lever 301, first the two half shells 390 and 389 can be inserted into the annular groove and, subsequently, with the shift knob 310 demounted, the outer sleeve 314 can be pushed over the shank 309 and the half shells 390 and 389. The sleeve in this case lies at the bottom against a step of the shank 309, so that the sleeve 314 cannot “slip” further downward as a result of gravity. The inner sleeve 313 has a plurality of sharp-edged bosses 370 placed onto the outer surface. These bosses 370 press into the relatively soft sleeve 314. On the one hand, demounting by the vehicle occupant is thereby impeded. On the other hand, a relatively rotationally fixed connection between the sleeve 314 and the inner sleeve 313 is defined, so that the sleeve rolling radially on the outside slides only on the contact surface 360 between the inner sleeve 313 shank 309.

In an alternative embodiment of the invention, the selector lever is transversely displaceable and is not pivotable. A possible embodiment for a transversely displaceable selector lever is shown in DE 100 03 140 C1.

The radially inner component may, to reduce friction, consist of a material which has a low coefficient of friction, as compared with steel, etc. Such a material is, for example, tetrafluoroethylene or PTFE.

Instead of the shank consisting of steel, another material may be provided. For example, the shank may consist of a steel core which is covered with a plastic, or else the shank consists entirely of a highly rigid and hard plastic.

In a further alternative embodiment of the invention, only a single sleeve is provided instead of a two-component sleeve.

It is also possible that the rolling sleeve itself rolls with respect to the shank. In this case, in principle, the sleeve forms a rolling-bearing outer ring which rolls,
on the outside, with respect to the inner edge of the gate shift slot, and
on the inside, by means of rolling bodies, with respect to the shank designed as a rolling-bearing inner ring.

The shank in this case does not have to be designed itself as a rolling-bearing inner ring, but may instead carry a rolling-bearing inner ring concentrically.

Under corresponding construction space conditions, the rolling sleeves do not necessarily have to be concentric to the shank, but may rotate about an eccentrically offset axis.

In an alternative embodiment of the invention, the two sleeves of the two-component sleeve may be separately expanded and put in place during the mounting of the selector lever. The two-component sleeve is thus formed from the two sleeves only after they have been placed onto the shank or after they have been inserted into the annular groove.

In an alternative embodiment of the invention, the positioning of the rolling sleeve in the axial direction may also take place with respect to the inner edge of the gate shift slot. Thus, for example, the sleeve may have, concentrically to the longitudinal axis of the shank, an annular groove into which the inner edge of the gate shift slot engages. The sleeve may in this case be manufactured from a relatively hard material with a low coefficient of friction in relation to steel. In this case, a soft and damping band is glued or a soft and damping ring is inserted into the groove bottom of the annular groove.

The division of the inner sleeve according to FIG. 1/FIG. 2 and the division into two half shells according to FIG. 10/FIG. 11 does not necessarily have to take place parallel to the longitudinal axis of the selector lever. For example, the division may also take place in a slope, that is to say with a pitch. Even a spiral helical section is possible.

Instead of the sharp-edge bosses, shown in FIG. 10/FIG. 11, for connecting the two sleeves, a peripherally continuous annular edge may also be provided.

Furthermore, it is possible to provide a step for the bottom and for the top on the inner sleeve, between which steps an elastomeric ring is held. Rough surfaces which make a frictional connection may also be envisaged.

A silicone may also be envisaged as a material for the elastically deformable sleeve.

Instead of the cardan joint for producing a pivotability about two orthogonal axes, it is also possible to use a ball joint.

The embodiments described are merely exemplary embodiments. A combination of the features described for different embodiments is likewise possible. Further features, in particular features not described, of the device parts belonging to the invention may be gathered from the geometries, illustrated in the drawings, of the device parts.

1: A selector lever (1) which is guided within a gate shift slot (2), wherein, in the region of the gate shift slot (2), a rolling body (two-component sleeve 12) is arranged rotatably on the selector lever (1) and is arranged so as to be rollable on the inner edge (20, 21) of the gate shift slot (2).

2: The selector lever as claimed in patent claim 1, wherein the selector lever (1) is pivotable about two axes orthogonal to one another.

3: The selector lever as claimed in patent claim 1, wherein the selector lever is transversely displaceable.

4: The selector lever as claimed in claim 1, wherein the rolling body (two-component sleeve 12) is so soft, at least on the outer circumference, that knocks of the rolling body (two-component sleeve 12) against the inner edge (20, 21) of the gate shift slot(2) are damped.

5: Selector lever as claimed in claim 1, wherein the rolling body (two-component sleeve 12) comprises at least two components (sleeves 13 and 14) which are connected rotationally fixedly to one another in the direction of rotation, in such a way that, during rolling, the rolling body rotates in relation to the selector lever shank (9).

6: The selector lever as claimed in claim 1, wherein the rolling body (two-component sleeve 12) is expandable 5 radially with respect to a longitudinal axis (6) of the selector lever (1).

7: A method for producing a selector lever (1), wherein a sleeve (12, 314) is pushed over a selector lever shank (9, 309) and is secured axially in an axial position (annular groove) of the selector lever shank (9, 309) in which the sleeve (12, 314) is rotatable with respect to the selector lever shank (9, 309) and rollable with respect to an inner edge (20, 21) of a gate shift slot (2, 302).

8: The method as claimed in patent claim 7, wherein the sleeve (12) is expandable for displacement over the selector lever shank (9) and latches positively in an annular groove.

9: The method as claimed in patent claim 7, wherein the sleeve (12, 314) has at least one division in the longitudinal direction.

10: The method as claimed in patent claim 8, wherein, for expansion, the sleeve (12) is elastically deformable.
